(19) United States
(12) Patent Application Publication
(10) Pub. No.: US 2011/0108488 A1
(43) Pub. Date: May 12, 2011

(54) BORON-SELECTIVE RESINS

(75) Inventors: Pierre Vanhoorne, Monheim (DE); Michael Schelhaas, Koln (DE)

(73) Assignee: LANXESS DEUTSCHLAND GMBH, LEVERKUSEN (DE)

(21) Appl. No.: 12/917,726

(22) Filed: Nov. 2, 2010

(30) Foreign Application Priority Data
Nov. 12, 2009 (DE) 10 2009 052 934.9

(51) Int. Cl. C02F 1/58; B01J 41/14; C02F 1/42; B01D 15/04

(52) U.S. Cl. 210/683; 521/32

(57) ABSTRACT

The present invention relates to boron-selective resins containing glucamide structures, a method for production thereof and also use thereof for removing boron from liquids, preferably from seawater, drinking water or process waters in or from the electronics industry.

The present invention relates to resins containing glucamide structures, a method for production thereof and also use thereof for removing boron from liquids, preferably from seawater, drinking water or process waters in or from the electronics industry.

### BACKGROUND OF THE INVENTION

Ion exchangers are used in many areas such as, for example, for softening water, for demineralizing and purifying aqueous solutions, for separating off and purifying sugar solutions and amino acid solutions and for producing high-purity water in the electronics and pharmaceuticals industry. However, the conventional ion exchangers can only take up poorly ionizable compounds such as silicon dioxide and boric acid, for example, with limitations.

Owing to its toxicity, boric acid and/or borate may only be present in drinking water in the trace range. This is a particular problem if the aim is to obtain drinking water from seawater, as is desirable in many regions of the world. Seawater contains many times the maximum permissible concentration of boric acid and/or borate for drinking water and the techniques for demineralizing seawater (reverse osmosis, conventional ion exchangers) are only able to reduce this concentration to the range acceptable for drinking water with great expenditure.

In the electronics industry also, dissolved boric acid or dissolved borate is undesirable, since the element boron is used for doping the semiconductors. In the process of producing silicon chips, the chips must be cleaned with water after various chemical reactions. Here, traces of boron in the form of dissolved boric acid and/or dissolved borate, even in the ppb range, markedly increase the number of faulty chips. Again, conventional ion exchangers are only able to guarantee boric acid or borate concentration in the sub-ppb range with restrictions.

In order to meet the requirements of these fields of application, resins are needed which are able to take up boric acid and/or borate selectively. In the case of preparation of drinking water from seawater, these resins must take up boric acid or borate preferentially (boron-selective resins), in order that other ions such as sodium, magnesium, calcium, chloride, nitrate, sulphate, which must remain in the drinking water in certain amounts, are not taken up together with boric acid and/or borate, or even in preference to boric acid and/or borate.

For use in said applications, the resins must have a very high uptake capacity for boric acid or borate. In the case of drinking water preparation, large volumes of water must be provided in a short time, which leads to very high flow rates of the water through the ion exchanger bed. In the case of the electronics industry, the very low concentrations of boric acid or borate dramatically decrease the frequency of contact between boric acid/borate and boron-selective groups. In order to be able to work efficiently, any contact must lead to immediate uptake of boric acid or borate.

Finally, the resins must be able to take up significant amounts of boric acid or borate per unit volume of resin, in order to prevent frequent exchange of the resin.

Not least, ion exchangers to be used as resins for the abovementioned applications most be available in industrial amounts, since, in particular in drinking water preparation, relatively large amounts of up to 300 m³ of resin are required per treatment plant.

Boron-selective resins are already described in the patent literature. For example, U.S. Pat. No. 3,567,369 and DD 279 377 mention the production of boron-selective resins by transesterification of chloromethylated styrene/divinylbenzene polymer beads with sugar derivatives. The sugar derivatives used are generally produced by reacting sugars such as glucose, fructose, galactose, ribose etc., with low-molecular-weight amines such as monomethylamine under reducing conditions. A typical example of such compounds is N-methylglucamine. These sugar derivatives are only obtainable on the world market in relatively small amounts and from few suppliers. Therefore, the availability of the boron-selective resins produced using these derivatives is restricted and the manufacturers are not able to provide larger amounts.

JP 2005325269 A describes boron-selective resins based on polyvinylamine and D-mannose. The production of these resins by a combination of inverse suspension polymerization in hydrocarbons, followed by a reduction with boranes, is technically very complex and unsuitable for providing boron-selective resins in industrial amounts.

For water preparation, there is therefore a requirement for boron-selective ion exchangers of high capacity and outstanding uptake kinetics that are available in industrial amounts.

It has now surprisingly been found that such resins can be made by reacting aminomethylated polymer beads with sugar acids and/or with sugar acid lactones, preferably with gluconic acid or gluconolactone.

### SUMMARY OF THE INVENTION

The object is achieved by, and the present invention therefore relates to, ion exchangers containing polyol structures of the general formula (I),

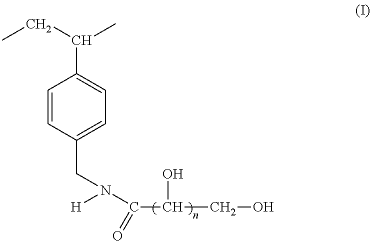

where
n is an integer 2, 3, 4 or 5.

However, the present invention also relates to a method for producing ion exchangers having polyol structures of the general formula (I)

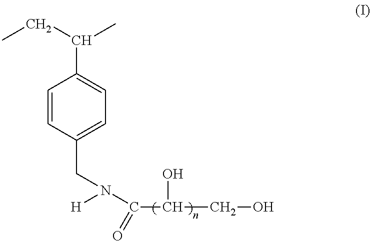

where
n is an integer 2, 3, 4 or 5, characterized in that
a) at least one monoethylenically unsaturated aromatic monomer and at least one multiethylenically unsaturated compound are polymerized in the presence of a pore-forming agent to give polymer beads,
b) the polymer beads are reacted by the chloromethylation method or the phthalimide method to give aminomethylated polymer beads,
c) the aminomethylated polymer beads are washed so as to be alkali free,
d) the aminomethylated polymer beads washed so as to be alkali free are reacted with at least one sugar acid and/or at least one sugar acid lactone in the presence of a solvent which allows the aminomethylated polymer beads to swell and simultaneously dissolves the sugar acid or sugar acid lactone sufficiently and
e) after the reaction the resultant boron-selective anion exchanger is washed with deionized water at temperatures of 20 to 120° C. and isolated by allowing to settle or by filtering.

Boron, in the context of the present invention, means boric acid or salts thereof, borates, preferably salts with alkali metals or alkaline earth metals, particularly preferably salts of boric acid with sodium, potassium or magnesium.

Boron-selective in the context of the present invention means selective for these above-mentioned boron compounds.

### DESCRIPTION

For producing the ion exchangers according to the invention, preferably, first of all, non-functionalized polymer beads are generated by suspension polymerization of non-functionalized monomers and these are provided in one or more downstream steps with the boron-selective polyol structure.

Non-functionalized monomers, preferably monoethylenically unsaturated aromatic monomers, are used, particularly preferably styrene, α-methylstyrene, vinyltoluene, t-butylstyrene or vinylnaphthalene. Mixtures of these monomers are also readily suitable, and also mixtures of monoethylenically unsaturated aromatic monomers having up to 20% by weight of other monoethylenically unsaturated monomers, preferably chlorostyrene, bromostyrene; acrylonitrile, methacrylonitrile; esters of acrylic acid or methacrylic acid, in particular preferably methyl methacrylate, ethyl methacrylate, methyl acrylate, ethyl acrylate, isopropyl methacrylate, butyl acrylate, butyl methacrylate, hexyl methacrylate, 2-ethylhexyl acrylate, ethylhexyl methacrylate, decyl methacrylate, dodecyl methacrylate, stearyl methacrylate, or isobornyl methacrylate; ethers and esters of vinyl alcohol, preferably vinyl acetate, ethyl vinyl ether, propyl vinyl ether, butyl vinyl ether, butanediol monovinyl ether, ethylene glycol monovinyl ether and diethylene glycol monovinyl ether. Very particular preference is given to polymer beads based on styrene or vinyltoluene.

Crosslinkers are added to the monomers. Preferred crosslinkers are multiethylenically unsaturated compounds. Particularly preference is given to divinylbenzene, divinyltoluene, trivinylbenzene, ethylene glycol dimethacrylate, ethylene glycol diacrylate, ethylene glycol divinyl ether, diethylene glycol divinyl ether, butanediol divinyl ether, octadiene and triallyl cyanurate. Very particularly preferably, divinylbenzene and trivinylbenzene are used, in particular especially preferably divinylbenzene. The crosslinkers can be used alone or as a mixture of various crosslinkers. The total amount of crosslinkers to be used is generally 0.1 to 80% by weight, preferably 0.5 to 60% by weight, particularly preferably 1 to 40% by weight, based on the sum of the ethylenically unsaturated compounds.

In a preferred embodiment of the present invention, for generating a pore structure in the non-functional polymer beads, at least one pore-forming agent—what is termed a porogen—is added to the monomers. Porogens which are used are preferably organic diluents. Particularly preferably, those organic diluents are used which dissolve to less than 10% by weight, preferably less than 1% by weight, in water. In particular, suitable porogens are toluene, ethylbenzene, xylene, cyclohexane, octane, isooctane, decane, dodecane, isododecane, methyl isobutyl ketone, ethyl acetate, butyl acetate, dibutyl phthalate, n-butanol, 4-methyl-2-pentanol and n-octanol. Very particular preference is given to toluene, cyclohexane, isooctane, isododecane, 4-methyl-2-pentanol or methyl isobutyl ketone.

Mixtures of the abovementioned pore-forming agents can also be used as porogen.

When added, the porogen is used in amounts of 10 to 200% by weight, preferably 25 to 150% by weight, particularly preferably 40 to 100% by weight, in each case based on the sum of the ethylenically unsaturated compounds.

In the production of the non-functional polymer beads, the abovementioned monomers, in a preferred embodiment of the present invention, are polymerized in aqueous suspension in the presence of a dispersion aid using an initiator.

Dispersion aids used are preferably natural or synthetic water-soluble polymers. Particularly preferably, gelatine, cellulose derivatives, starch, poly(vinyl alcohol), polyvinylpyrrolidone, polyacrylic acid, polymethacrylic acid or copolymers of (meth)acrylic acid or (meth)acrylic esters are used. Very particularly preferably, gelatine or cellulose derivatives are used, in particular cellulose esters or cellulose ethers, such as carboxymethylcellulose, methylcellulose, hydroxyethylcellulose or methylhydroxyethylcellulose. When the dispersion agents are used, the amount used is generally 0.05 to 1% by weight, preferably 0.1 to 0.5% by weight, based on the water phase.

In a further preferred embodiment of the present invention, initiators are used. Suitable initiators are compounds which form free radicals on temperature elevation. Preferably, peroxy compounds are used, particularly preferably dibenzoyl peroxide, dilauryl peroxide, bis(p-chlorobenzoyl)peroxide, dicyclohexyl peroxydicarbonate or tert-amylperoxy-2-ethylhexane and also azo compounds, particularly preferably 2,2′-azobis(isobutyronitrile) or 2,2′-azobis(2-methylisobutyronitrile) or else aliphatic peroxyesters, preferably tert-butyl peroxyacetate, tert-butyl peroxyisobutyrate, tert-butyl peroxypivalate, tert-butyl peroxyoctoate, tert-butyl peroxy-2-ethylhexanoate, tert-butyl peroxyneodecanoate, tert-amyl peroxypivalate, tert-amyl peroxyoctoate, tert-amyl peroxy-2-ethylhexanoate, tert-amyl peroxyneodecanoate, 2,5-bis(2-ethylhexanoylperoxy)-2,5-dimethylhexane, 2,5-dipivaloyl-2,5-dimethylhexane, 2,5-bis(2-neo-decanoylperoxy)-2,5-dimethylhexane, di-tert-butyl peroxyazelate and di-tert-amyl peroxyazelate.

In the event that initiators are used, these are generally employed in amounts of 0.05 to 6.0% by weight, preferably 0.1 to 5.0% by weight, particularly preferably 0.2 to 2% by weight, based on the sum of the ethylenically unsaturated compounds.

The water phase can contain a buffer system which sets the pH of the water phase to a value between 12 and 3, preferably between 10 and 4. Particularly highly suitable buffer systems contain phosphate salts, acetate salts, citrate salts or borate salts.

It can be advantageous to use an inhibitor dissolved in the aqueous phase. Inhibitors that come into consideration are not only inorganic but also organic substances. Examples of inorganic inhibitors are nitrogen compounds, preferably hydroxylamine, hydrazine, sodium nitrite and potassium nitrite. Preferred organic inhibitors are phenolic compounds, particularly preferably hydroquinone, hydroquinone monomethyl ether, resorcinol, pyrocatechol, tert-butylpyrocatechol or condensation products of phenols with aldehydes. Further preferred organic inhibitors are nitrogenous compounds, particularly preferably diethylhydroxylamine or isopropylhydroxylamine. Resorcinol is particularly preferred as inhibitor. The concentration of the inhibitor is 5-1000 ppm, preferably 10-500 ppm, particularly preferably 20-250 ppm, based on the aqueous phase.

The organic phase can be dispersed into the aqueous phase as droplets by stirring (for producing heterodisperse ion exchangers having heterodisperse particle size distribution) or by jetting (for producing monodisperse ion exchangers having monodisperse particle size distribution). Organic phase is taken to mean the mixture of monomer(s), crosslinker(s), porogen(s) and, if appropriate, initiator(s). In the classical dispersion polymerization, the organic droplets are generated by stirring. On a 4 litre scale, typically stirrer speeds of 250 to 400 rpm are used. If the droplets are generated by jetting, it is advisable to encapsulate the organic droplets to maintain the uniform droplet diameter. Methods of microencapsulating jetted organic droplets are described, for example, in EP-A 0 046 535, the content of which with respect to microencapsulation is hereby incorporated by the present application.

EP-A 0 046 535 in fact relates to a method for producing polymer beads of uniform particle size and uniform quality which is characterized in that
i) from the monomer or polymerization mixture that is to be polymerized, droplets of uniform size are generated by injection into a continuously supplied liquid that is substantially immiscible with the monomer or polymerization mixture;
these droplets of uniform size in said liquid are continuously encapsulated by stable under the polymerization conditions to be employed or first of all with a casing that is stable to shear forces and this casing that is stable to shear forces in a second partial step is continuously or discontinuously cured to form a casing that is stable under the polymerization conditions to be employed;
iii) the monomer or polymerization mixture droplets encapsulated with a casing stable under the polymerization conditions to be employed are then polymerized, with the proviso
   α) that the monomer or polymerization mixture is injected into the continuously supplied continuous phase co-currently thereto;
   β) that the generation of the droplets and encapsulation thereof are performed in different regions of the reaction vessel;
   γ) that the process steps α) and β) are carried out in such a manner that no forces altering the integrity of the droplets act on the droplets from their generation up to their encapsulation.

The encapsulation with a casing that is stable under the polymerization conditions to be employed is carried out in two partial steps when, although the casings generated around the droplets by the microencapsulation methods are stable to shear forces, said casings are not stable under the polymerization conditions to be employed.

In this case, the casings must be cured in a second process step, which can be carried out continuously or discontinuously, to form casings that are stable under the polymerization conditions. The curing step can be carried out in a separate working operation in a separate reaction vessel: preferably, however, it is performed in the same reaction vessel.

If, in contrast, the casings generated around the droplets by the microencapsulation method are already stable under the polymerization conditions to be employed, the curing step is omitted, and the encapsulation is carried out in one step with the casings that are stable under the polymerization conditions to be employed.

Casings are designated as stable to shear forces in the context of the method according to EP-A 0 046 535 if they withstand, without being damaged, stirring motions of an intensity as are employed under the conditions of customary suspension polymerizations in order to produce droplets of equal size.

By means of the combination of generating monomer or polymerization mixture droplets of uniform size, stabilizing these droplets by encapsulating and polymerizing the droplets encapsulated with a casing stable under the polymerization conditions, while maintaining defined conditions, according to EP-A 0 046 535 polymer beads are obtained, which beads are distinguished by approximately equal particle size and by uniformity in their physical properties such as grain stability, breaking strength etc.

The median particle size of the monomer droplets optionally encapsulated in the process step a) according to the invention is 10-1000 μm, preferably 100-1000 μm.

The ratio of the organic phase to the aqueous phase is generally 1:20 to 1:0.6, preferably 1:10 to 1:1, particularly preferably 1:5 to 1:1.2.

However, the organic phase can alternatively be added in what is termed the seed-feed method to a suspension of seed polymers which take up the organic phase, according to EP-A 0 617 714, the teaching of which is hereby incorporated by the present application. Monodisperse ion exchangers may also be produced in this manner.

According to EP-A 0 617 714 a number of gel-type copolymer seed particles are initially prepared. The seed particles are produced by polymerization of a first monomer mixture comprising at least one first monovinylidene monomer and one first crosslinking monomer. The seed particles optionally contain a free-radical source therein, which is capable of initiating the polymerization of ethylenically unsaturated monomers.

The seed particles are then imbided with a second monomer mixture comprising a phase-separating diluent, at least one second monovinylidene monomer, a second crosslinking monomer and a free-radical polymerization initiator. The free-radical initiator is optional for embodiments in which the seed particles contain a free-radical source. The phase-separating diluents and the second monomervinylidene monomer are selected in such a manner that they have a solubility parameter and a dipole moment which are compatible with the solubility parameter and the dipole moment of the first monovinylidene monomer, such that at least 70% by weight of the second monomer mixture is imbibed by the seed particles.

The imbibed seed copolymer particles are then kept under suspension polymerization conditions for a sufficient time period to achieve a desired degree of conversion of monomer into copolymer and to obtain the porous copolymer beads.

The median particle size of the seed polymers swollen by the organic phase according to process step a) in the method according to the invention is 5-1200 μM, preferably 20-1000 μm. The ratio of the sum of organic phase+seed polymer to the aqueous phase is generally 1:20 to 1:0.6, preferably 1:10 to 1:1, particularly preferably 1:5 to 1:1.2.

The polymerization of the monomers in the process step a) according to the invention is preferably carried out at elevated temperature. The polymerization temperature depends here on the decomposition temperature of the initiator optionally used in a preferred embodiment and is typically in the range from 50 to 150° C., preferably 60 to 120° C. The polymerization time is 30 minutes to 24 hours, preferably 2 to 15 hours.

At the end of the polymerization, the non-functional polymer beads are separated off from the aqueous phase, for example on a vacuum filter, and optionally dried.

In the process step b) according to the invention, the functionalization to give amine-containing polymer beads can proceed by various methods. For instance, the polymer beads can be reacted to form amine-containing polymer beads by chloromethylation and subsequent reaction with, for example, hexamethylenetetramine according to DD 79152 and IL 52121.

A preferred method for reacting non-functional polyvinylaromatic polymer beads to form amine-containing polymer beads in the process step b) according to the invention is what is termed the phthalimide method according to U.S. Pat. No. 4,952,608, DAS 2 519 244 and EP-A 1 078 690, the teachings of which with respect to the phthalimide method are hereby incorporated by the present application. EP-A 1 078 690, for example, relates to a method for producing monodisperse ion exchangers having chelating functional groups, characterized in that
l) monomer droplets of at least one monovinylaromatic compound and at least one polyvinylaromatic compound and also optionally a porogen and/or optionally an initiator or an initiator combination are reacted to form monodisperse crosslinked polymer beads,
m) these monodisperse crosslinked polymer beads are amidomethylated with phthalimide derivates,
n) the amidomethylated polymer beads are reacted to form aminomethylated polymer beads and
o) the aminomethylated polymer beads are reacted with chelating groups to form ion exchangers.

In a preferred embodiment, therefore, the non-functionalized polyvinylaromatic polymer beads from process step a) are condensed with phthalimide derivatives. The catalyst used is oleum, sulphuric acid or sulphur trioxide.

The phthalic acid residue is eliminated and the aminomethyl group thereby exposed by treating the phthalimidomethylated crosslinked polymer beads with aqueous or alcoholic solutions of an alkali metal hydroxide, such as sodium hydroxide or potassium hydroxide, at temperatures between 100 and 250° C., preferably 120-190° C. The concentration of the sodium hydroxide solution is in the range from 10 to 50% by weight, preferably 20 to 40% by weight. Alternatively, the phthalic acid residue can be eliminated by treating the phthalimidomethylated crosslinked polymer beads with hydrazine or hydrazine-containing solutions.

This method makes it possible to produce aminomethyl group-containing crosslinked polymer beads having a substitution of the aromatic nuclei greater than 1.

The resultant aminomethylated polymer beads are finally washed in the process step c) according to the invention with deionized water so as to be alkali free.

The aminomethylated polymer beads are reacted to form a boron-selective ion exchanger containing polyol structures in the process step d) according to the invention by reacting the aminomethylated polymer beads with at least one sugar acid and/or at least one sugar acid lactone.

Sugar acid in the context of the present invention is taken to mean polyhydroxy C5-C7-carboxylic acids, in particular aldonic acid, uronic acid, erythronic acid, threonic acid, ribonic acid, arabinonic acid, xylonic acid, lyxonic acid, gluconic acid, mannonic acid, gulonic acid, galactonic acid, idonic acid, talonic acid, allonic acid, altronic acid, glucoheptonic acid, glucuronic acid or galacturonic acid. Particular preference is given to gluconic acid, mannonic acid, glucuronic acid and galacturonic acid.

Sugar acid lactones preferably used are gluconolactones, galactonolactones, mannonolactones, gulonolactones and heptagluconolactones. Particularly preferably, D-glucono-[delta]-lactone [CAS-No. 90-80-2], D-galactono-[gamma]-lactone [CAS-No. 2782-07-2], L-mannono-[gamma]-lactone [CAS-No. 22430-23-5], D-gulono-[gamma]-lactone [CAS-No. 6322-07-2], L-gulono-[gamma]-lactone [CAS-No. 1128-23-0], [alpha]-D-heptaglucono-[gamma]-lactone [CAS-No. 60046-25-5] are used, very particularly preferably D-glucono-[delta]-lactone [CAS-No. 90-80-2].

The sugar acids or the sugar acid lactones can be used individually or as a mixture of different sugar acids, different sugar acid lactones or as a mixture of sugar acids with sugar acid lactones.

For reacting the aminomethylated polymer beads, preferably at least 0.5 mol of sugar acid or sugar acid lactone is used, based on 1 mol of amine in the aminomethylated polymer beads. Particularly preferably, a ratio of 0.8 to 3 mol of sugar acid or sugar acid lactone is used per mole of amine, very particularly preferably 1.0 to 2 mol of sugar acid or sugar acid lactone per mole of amine.

The reaction proceeds in the presence of a suitable solvent. Suitable solvents are those which swell the aminomethylated polymer beads and simultaneously dissolve the sugar acid or the sugar acid lactone sufficiently. Preferred solvents are dimethylformamide, dimethyl sulphoxide, C1-C3 alcohols and water. Particular preference is given to water. Mixtures of the suitable solvents can also be used.

The amount of solvent used is not critical for the reaction. It is generally selected in such a manner that the batch during the entire reaction time remains stirrable. Amounts of 1.2 to 5 ml of solvent per ml of resin have proved to be readily practicable.

The temperature at which the reaction is carried out is preferably in the range between room temperature and 120° C. Particularly preferably, temperatures between 10 and 100° C., in particular preferably between 15 and 80° C., are employed.

After the reaction, the boron-selective anion exchanger obtained is washed in the process step e) according to the invention with deionized water at temperatures of 20 to 120° C., preferably from 20 to 70° C., and finally isolated by allowing to settle or by filtering.

The boron-selective resins according to the invention have a median particle size between 100 μm and 1000 μm, preferably between 200 and 800 μm. For determining the median particle size and the particle size distribution, customary methods such as sieving analysis or image analysis are suitable. The median particle size D, in the context of the present invention, is taken to mean the 50% value (0 (50)) of the volume distribution. The 50% value (Ø(50)) of the volume distribution gives the diameter beneath which 50% by volume of the particles fall.

In a preferred embodiment of the present invention, monodisperse boron-selective resins are produced. Monodisperse particle size distributions in the context of the present invention have a volume fraction of particles between 0.9 D and 1.1 D of at least 75 vol. %, preferably at least 85 vol. %, particularly preferably at least 90 vol. %.

In a preferred embodiment of the present invention, the boron-selective resins according to the invention have a macroporous structure. Macroporous structure in the context of the present invention is taken to mean, in accordance with IUPAC (K. Hone et al., Pure and Applied Chemistry 2004, 76(4), 900) a structure having pores which has a median diameter greater than 50 nm. Preferably, the macroporous boron-selective resins according to the invention have a total pore volume, measured on dried resin using the method of mercury intrusion porosimetry, of at least 0.1 cm³/g, particularly preferably at least 0.5 cm³/g.

Reacting the aminomethylated polymer beads with a sugar acid or a sugar acid lactone forms, in the polymer beads, polyol structures of the general formula (I):

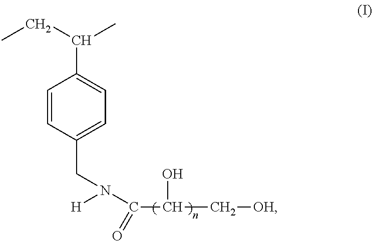

where
n is an integer between 2 and 5.

The present invention therefore also relates to ion exchangers based on at least one aromatic monomer which contain polyol structures of the general formula (I) and have a median particle diameter D between 100 and 1000 μm.

It will be understood that the specification and examples are illustrative but not limitative of the present invention and that other embodiments within the spirit and scope of the invention will suggest themselves to those skilled in the art.

### EXAMPLES

### Example 1

### Production of Monodisperse Aminomethylated Polymer Beads

### 1a) Production of Monodisperse Macroporous Polymer Beads Based on Styrene, Divinylbenzene and Ethylstyrene

In a 10 l glass reactor, 3000 g of deionized water were charged and a solution of 10 g of gelatine, 16 g of disodium hydrogenphosphate dodecahydrate and 0.73 g of resorcinol in 320 g of deionized water were added and mixed. The mixture was brought to and maintained at a temperature of 25′C. With stirring, a mixture of 3200 g of microencapsulated monomer droplets obtained by jetting and having a narrow particle size distribution of 3.6% by weight of divinylbenzene and 0.9% by weight of ethylstyrene (used as commercially obtainable isomeric mixture of divinylbenzene and ethylstyrene containing 80% divinylbenzene), 0.5% by weight of dibenzoyl peroxide, 56.2% by weight of styrene and 38.8% by weight of isododecane (technical mixture of isomers having a high fraction of pentamethylheptane) were then added, wherein the microcapsules consisted of a formaldehyde-cured complex coacervate of gelatine and a copolymer of acrylamide and acrylic acid, and 3200 g of aqueous phase having a pH of 12 were added. The median particle size of the monomer droplets was 460 μm.

The batch was polymerized to exhaustion with stirring by temperature elevation according to a temperature programme starting at 25′C and ending at 95° C. The batch was cooled, washed over a 32 μm sieve and then dried at 80° C. in a vacuum. This produced 1893 g of a spherical polymer having a median particle size of 440 μm, narrow particle size distribution and smooth surface.

The polymer was chalky white in appearance and had a bulk density of approximately 370 g/l.

### 1b) Production of Monodisperse Amidomethylated Polymer Beads

At room temperature, 2373 g of dichloroethane, 705 g of phthalimide and 505 g of 29.2% strength by weight formalin were charged. The pH of the suspension was set to 5.5 to 6 using sodium hydroxide solution. The water was then removed by distillation. Then, 51.7 g of sulphuric acid were added. The resultant water was removed by distillation. The batch was cooled. At 30° C., 189 g of 65% strength oleum and then 371.4 g of monodisperse polymer beads from Example 1a) were metered in. The suspension was heated to 70° C. and stirred at this temperature for a further 6 hours. The reaction broth was withdrawn, deionized water was added and residual amounts of dichloroethane were removed by distillation.

Yield of amidomethylated polymer beads: 2140 ml
Composition from elemental analysis:
carbon: 75.3% by weight;
Hydrogen: 4.9% by weight;
Nitrogen: 5.8% by weight;
Remainder: oxygen.

### 1c) Production of Monodisperse Aminomethylated Polymer Beads

To 2100 ml of amidomethylated polymer beads from 1b), 1019 g of 45% strength by weight sodium hydroxide solution and 406 ml of deionized water at room temperature were added. The suspension was heated to 180° C. and stirred at this temperature for 6 hours.

The resultant polymer beads were washed with deionized water.

Yield of aminomethylated polymer beads: 1770 ml
This gave an estimated total yield over steps 1b and 1c of 1804 ml
Composition from elemental analysis: nitrogen: 10.90% by weight
Amount of aminomethyl groups in moles per litre of aminomethylated polymer beads: 2.29.

From the composition by elemental analysis of the aminomethylated polymer beads it may be calculated that on a statistical average per aromatic nucleus —originating from the styrene and divinylbenzene units—1.06 hydrogen atoms were substituted by aminomethyl groups.

### Example 2

### Production of a Macroporous, Monodisperse, Boron-Selective Anion Exchanger in Ethanol as Solvent

An amount of 250 ml of a water-moist, monodisperse, macroporous aminomethylated resin containing 2.57 mol of amine per litre of resin, produced in a similar manner to Example 1, was charged together with 115.7 g of D-glucono-[delta]-lactone in 500 ml of ethanol, heated to 80° C. and kept at reflux for 24 hours.

Thereafter, the suspension was cooled to room temperature.

The resin was transferred to a column and successively washed with 2 litres of ethanol and 4 litres of deionized water.

This produced 435 ml of a water-moist, monodisperse, macroporous, boron-selective resin. The moist resin had a dry weight of 0.36 g per millilitre of resin and a nitrogen content of 4.8% by weight with a static boron capacity of 5.6 g of boron per litre of resin.

### Example 3

### Production of a Macroporous, Monodisperse, Boron-Selective Anion Exchanger in Ethanol as Solvent

An amount of 250 ml of a water-moist, monodisperse, macroporous aminomethylated resin containing 2.57 mol of amine per litre of resin, produced in a similar manner to Example 1, was charged together with 347.1 g of D-glucono-[delta]-lactone in 500 ml of ethanol, heated to 80° C. and kept at reflux for 24 hours.

Thereafter the suspension was cooled to room temperature.

The resin was transferred to a column and successively washed with 2 litres of ethanol and 4 litres of deionized water.

This produced 435 ml of a water-moist, monodisperse, macroporous, boron-selective resin. The moist resin had a dry weight of 0.36 g per millilitre of resin and a nitrogen content of 4.7% by weight with a static boron capacity of 5.5 g of boron per litre of resin.

### Example 4

### Production of a Macroporous, Monodisperse, Boron-Selective Anion Exchanger in Water as Solvent

An amount of 250 ml of a water-moist, monodisperse, macroporous, aminomethylated resin containing 2.57 mol of amine per litre of resin, produced in a similar manner to Example 1, was charged together with 115.7 g of D-glucono-[delta]-lactone in 500 ml of deionized water and subsequently stirred at room temperature for 24 h.

The resin was transferred to a column and washed with 6 litres of deionized water.

This produced 440 ml of a water-moist, monodisperse, macroporous, boron-selective resin. The moist resin had a dry weight of 0.34 g per millilitre of resin and a nitrogen content of 4.7% by weight with a static boron capacity of 7.9 g of boron per litre of resin.

### Example 5

### Determination of the Boron Uptake Kinetics of the Resins

Each resin present for analysis was treated as follows:

An amount of 100 ml of resin was successively eluted in a column with 500 ml of 6.5% strength by weight hydrochloric acid, 500 ml of deionized water, 500 ml of 4% strength by weight sodium hydroxide solution and 500 ml of deionized water.

Then, a total of 180 litres of a boric acid solution (15 mg of boric acid per litre of deionized water, equivalent to 2.62 mg of boron/l) were added to the column at a rate of 2 litres per hour. Every 4 hours, a 20 ml sample was taken from the effluent of the column. The boron content of each sample thus taken was determined by analysis.

When the boron content of the effluent exceeded 0.25 mg/l, the capacity of the column was considered to be exhausted (breakthrough of boric acid).

From the difference between boron content of the feed and boron content of the effluent up to the time of breakthrough, the amount of boron taken up per litre of resin up to breakthrough of the boric acid is calculated. This amount of boron taken up per litre of resin is termed the dynamic boron capacity of the resin.

The results of the measurements on the resins according to the invention and on a commercially obtainable boron-selective resin are as follows:

TABLE 1
Boron uptake kinetics of the boron-selective resins
from Examples 2 and 3 compared with the commercially
available boron-selective resin Lewatit ® MK51
from Lanxess Deutschland GmbH, Leverkusen

| | Example 2 | Example 3 | |
|---|---|---|---|
| Time | (according to | (according to | Lewatit ® MK51 |
| (h) | the invention) | the invention) | (prior art) |
| | Amount of boric acid taken up (g of boron per litre of resin) | | |
| 5 | <0.05 | <0.05 | <0.05 |
| 17 | <0.05 | <0.05 | <0.05 |
| 29 | <0.05 | <0.05 | <0.05 |
| 41 | <0.05 | <0.05 | <0.05 |
| 53 | <0.05 | <0.05 | <0.05 |
| 57 | <0.05 | — | 0.228 |
| 61 | — | — | 0.435 |
| 65 | 0.087 | <0.05 | 0.519 |
| 69 | 0.451 | 0.309 | — |
| | Dynamic boron capacity of the resin (g of boron per litre of resin) | | |
| | 3.19 | 3.25 | 2.73 |

It can be seen that the resins according to the invention possess a significantly increased dynamic boron capacity compared with the commercial resin.

### Analysis

### Determination of the Static Boron Capacity of the Resins

Approximately 20 ml of exchanger were rinsed into a glass filter column using deionized water and eluted with 600 ml of sodium hydroxide solution (4% by weight) in the course of 30 min. The resin was extracted by washing with deionized water to neutral effluent.

Exactly 5 ml of the treated ion exchanger were shaken and rinsed into a 250 ml plastic bottle with deionized water. Using a sieve tube the supernatant water was removed. Using a 100 ml bulb pipette, 200 ml of a boric acid solution (6.18 g/l of boric acid) were added thereto and shaken for 60 min on a shaking machine.

5 ml each of the starting solution and of the solution after shaking for one hour were added by means of a pipette to a titration beaker and diluted with 30 ml of deionized water. To this was added 1 g of mannitol and the mixture was titrated with NaOH (0.1 mol/l). The NaOH consumption (in ml) was noted.

The static boric acid capacity of the resin was determined by the following formula:

(NaOH consumption of the starting solution−NaOH consumption of the solution after one hour of shaking)×8.648=static boron capacity of the resin in g of boron per litre of resin.

What is claimed is:

1. An ion exchanger, having polyol structures of the general formula (I), 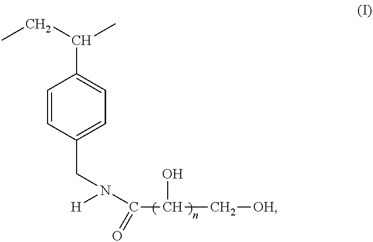
where
n is an integer 2, 3, 4 or 5.

2. An ion exchanger, according to claim 1, having a monodisperse particle size distribution.

3. An ion exchanger, according to claim 2, wherein the median particle diameter D is between 100 and 1000 μm.

4. A method for producing ion exchangers having polyol structures of the general formula (I) 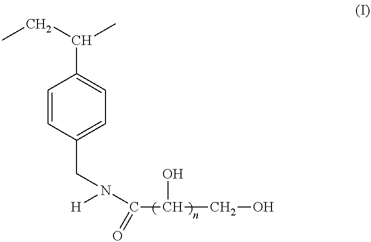
where
n is an integer 2, 3, 4 or 5, wherein
a) at least one monoethylenically unsaturated aromatic monomer and at least one multiethylenically unsaturated compound are polymerized in the presence of a pore-forming agent to give polymer beads,
b) the polymer beads are reacted by the chloromethylation method or the phthalimide method to give aminomethylated polymer beads,
c) the aminomethylated polymer beads are washed so as to be alkali free,
d) the aminomethylated polymer beads washed so as to be alkali free are reacted with at least one sugar acid and/or at least one sugar acid lactone in the presence of a solvent which allows the aminomethylated polymer beads to swell and simultaneously dissolves the sugar acid or sugar acid lactone sufficiently and
e) after the reaction the resultant boron-selective anion exchanger is washed with deionized water at temperatures of 20 to 120° C. and isolated by allowing to settle or by filtering.

5. A method for producing ion exchangers according to claim 4, wherein gluconic acid, galactonic acid, mannonic acid, gulonic acid or heptagluconic acid is used as sugar acid.

6. A method for producing ion exchangers according to claim 4, wherein lactone, gluconolactone, galactonolactone, mannonolactone, gulonolactone or heptagluconolactone is used as sugar acid.

7. A method for producing ion exchangers according to claim 4, wherein the organic diluents are used as pore-forming agents.

8. A method for producing ion exchangers according to claim 4, wherein the polymerization in step a) is carried out by the seed-feed method or the jetting method to generate a monodisperse particle size distribution.

9. A method of using the ion exchangers according to claim 1 for selectively separating off boron from liquids.

10. A method of use according to claim 9, wherein the liquids are seawater, drinking water or process waters in or from the electronics industry.
